(19) United States
(12) Patent Application Publication
(10) Pub. No.: US 2014/0102737 A1
(43) Pub. Date: Apr. 17, 2014

(54) BRUSH CUTTER AND WING PLOW MOUNT THEREFORE

(71) Applicant: Christopher B. Isbill, Midland (CA)

(72) Inventor: Christopher B. Isbill, Midland (CA)

(21) Appl. No.: 14/056,465

(22) Filed: Oct. 17, 2013

Related U.S. Application Data
(60) Provisional application No. 61/714,880, filed on Oct. 17, 2012.

(51) Int. Cl. A01D 42/04; A01D 34/73

(52) U.S. Cl. CPC A01D 42/04; A01D 34/73
USPC 172/247; 56/255

(57) ABSTRACT

The brush cutter has an elongated frame and a series of cutting discs mounted in line along that frame, and can be mounted in a wing-plow arrangement via wing-plow attachments. The wing-plow attachments comprise a wing-plow mast having a first raisable connection and a wing-plow push bar having second raisable connection. The elongated frame is connected at both ends thereof to the first and second raisable connections respectively, such that both ends are independently adjustable in height by the wing-plow mast and the wing-plow push bar.

### CROSS REFERENCE TO RELATED APPLICATIONS

This application claims the benefit of provisional application No. 61/714,880, filed Oct. 17, 2012, the disclosure of which is hereby incorporated by reference.

### FIELD

This invention pertains to brush cutters for clearing shrubs and other vegetation from road shoulders, and more particularly it pertains to brush cutters that are mountable to road graders and snow-plow trucks.

### BACKGROUND

The maintenance of roadways in the countryside and along wood lots require periodic cutting of alders, poplar trees and other fast growing shrubs along the road shoulders, to prevent vegetation from spreading onto the roadways. This work is done by various apparatus including brush cutters mounted on farm tractors and front-end loaders.

Examples of these brush cutters are disclosed in the following documents.

U.S. Pat. No. 5,123,462 issued on Jun. 23, 1992 to T. A. Davision. The brush cutter described in this document has a large cutting disc mounted on a frame that is supported to a front-end loader. The disc can be swung side-to-side in the front of the loader.

U.S. Pat. No. 6,311,464 issued to H. Neuerburg et al. on Nov. 6, 2001. This document discloses a series of disc-like cutters mounted inline on a bar. The bar is suspending at its middle to an arm mounted to the back of a tractor. The arm can be swung sideways to mow grass alongside the tractor.

CA Patent 510,271 issued to Earl W. Holmes on Feb. 22, 1955. The apparatus disclosed in this document comprises a sickle bar extending from an arm having a pivot at each end. The arm extends from a turntable on the frame of a truck. The sickle bar is movable to cut grass along the near slope and the far slope of a ditch.

CA Patent 914,430 issued to V. D. L. Cornelis on Nov. 14, 1972. This document discloses a pair of mower rotors mounted side-by-side on the three-point hitch of a farm tractor. The mower rotors are mounted offset from the line of travel of the tractor, such as to mow a strip of grass alongside the tractor.

CA Patent 1,004,858 issued to Pieter A. Oosterling et al. on Feb. 8, 1977. This document discloses a series of disc-like cutters mounted inline on a bar extending from the three-point hitch of a farm tractor. The bar-type cutter extends sideways from the tractor such as a conventional sickle bar type hay mower.

Although the apparatus of the prior art deserve undeniable merits, it is believed that a more convenient way for clearing brushes along road shoulders is to do it using a brush cutter mounted as a wing plow on a road grader or on a similar snow-plowing vehicle. Advantages of such mounting are numerous and include the fact that its operation is as easy as operating a wing plow.

### SUMMARY

In the present invention, there is provided a brush cutter mounted as a wing plow on a road grader, a snow plow truck or other snow-plowing vehicle.

Broadly, in one aspect of the present invention, there is provided a road vehicle having wing-plow attachments and a brush cutter mounted as a wing plow to the wing-plow attachments. The brush cutter has an elongated frame and a series of cutting discs mounted in line along that frame. The wing-plow attachments comprise a wing-plow mast having a first raisable connection and a wing-plow push bar having second raisable connection. The elongated frame is connected at both ends thereof to the first and second raisable connections respectively, such that both ends are independently adjustable in height by the wing-plow mast and the wing-plow push bar.

This mounting of the brush cutter is as agile as a wing plow to clear road shoulders. The brush cutter can be manipulated to leap over mail boxes, fence posts, large rocks, stumps and driveway markers, whether these obstacles are located at the near end or the far end hereof.

In another aspect of the present invention, the hydraulic valves used to operate the brush cutter are the same valves as those used to operate a wing plow and these valves are used in a same way as to operate a wing plow, such that the brush cutter is easily workable by snow-plow operators.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the present invention is illustrated in the accompanying drawings, in which like numerals denote like parts throughout the several views, and in which:

FIG. 1 illustrates a partial side view of a road grader and a preferred brush cutter mounted to the road grader as a wing plow;

FIG. 2 is a partial perspective side view of the road grader and a first example of a brush cutter mounted to the road grader;

FIG. 3 is a front view of the road grader and brush cutter adjusted to different positions;

FIG. 4 is a partial top view of the road grader and brush cutter;

FIG. 5 is a detail view of the near connection on the snow plow mast on the brush cutter, as shown in detail circle 5 in FIG. 4;

FIG. 6 is a detail view of the far connection on the snow-plow push-bar and the brush cutter, as shown in detail circle 6 in FIG. 4;

FIG. 7 is a partial plan view of the brush cutter first example illustrating an alignment relative to its direction of movement.

FIG. 8 is an oblique view showing a second example of a brush cutter.

### DETAILED DESCRIPTION

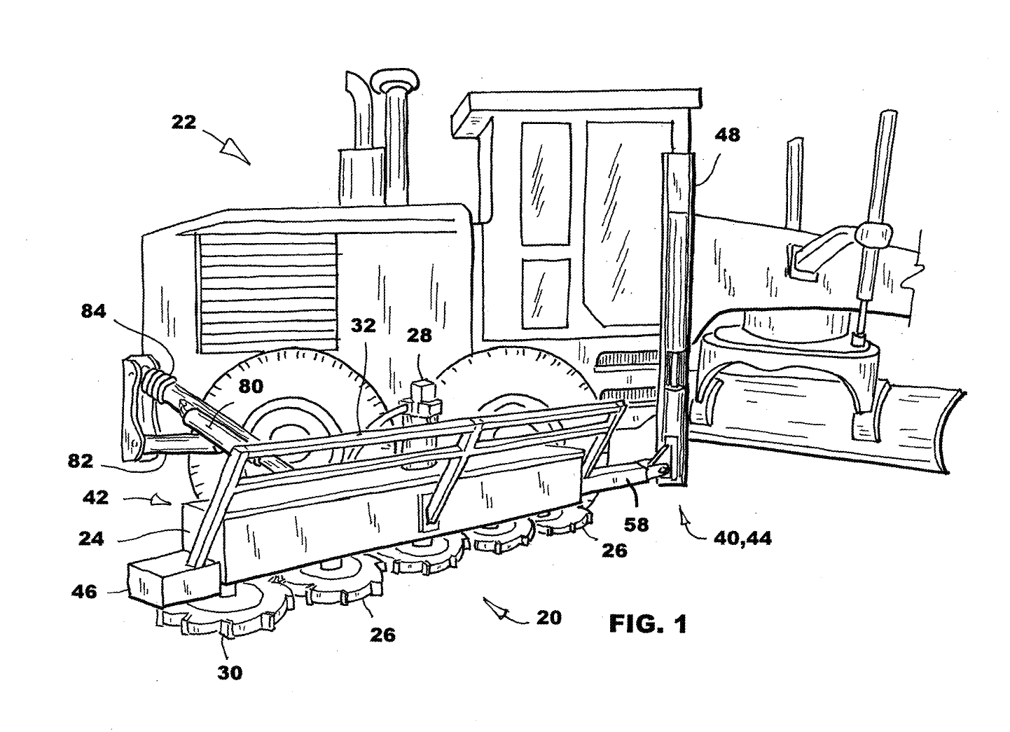

Referring back to FIG. 1 there is illustrated therein, the preferred brush cutter 20 mounted as a wing plow on a road grader 22. The preferred brush cutter 20 has a bar-like elongated frame 24 and a series of cutting discs 26 mounted in-line to this frame 24.

The brush cutter 20 is supported to the road grader 22 at two connection points. The connection point closer to the road grader 22 is referred to as the near end connection 40 and the other connection point is referred to as the far end connection 42. Similarly, the portion of the brush cutter closer to the road grader 22 is referred to as the near end 44 and the portion 20 farther away from the road grader is referred to as the far end 46.

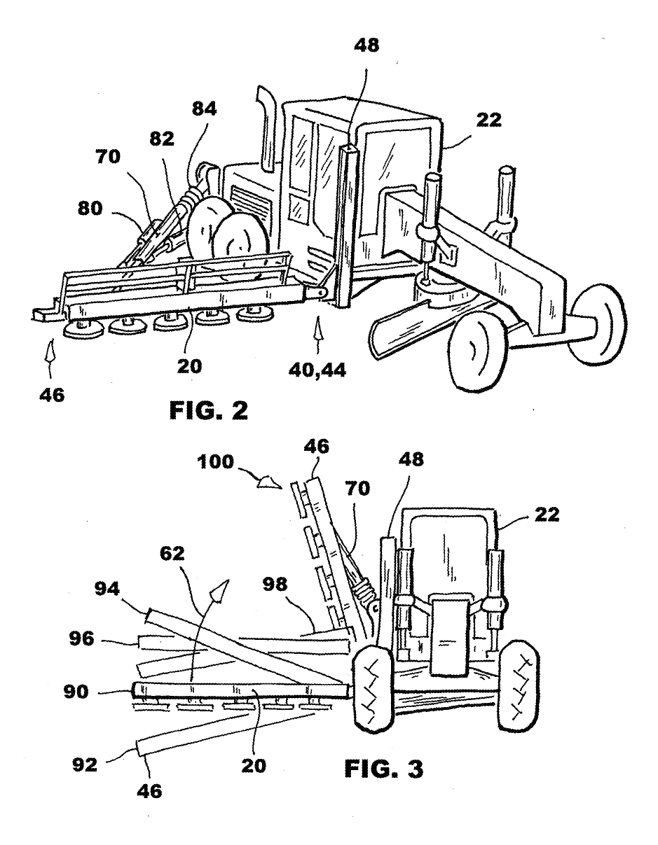

Referring to FIGS. 1-5, the near end connection 40 has a portion thereof that is integrated in the snow plow mast 48 of the road grader 22. The snow plow mast 48 has an hydraulic cylinder mounted therein, such that the near end connection 40 can be lifted up and lowered down using an hydraulic valve in the cab of the grader 22. The hydraulic valve mentioned above is one that is normally used to control the movement of a wing plow. This hydraulic valve belongs to the wing-plow valve bank. The snow plow mast 48 is of a conventional type for supporting a wing plow, and therefore no further explanation is deemed necessary to describe this mast.

The near end connection 40 consists of a clevis 50, a plate 52, and a pin 54 passing through the clevis 50 and through the plate 52. Preferably, the plate 52 is mounted to a pivot 56 having a vertical axis of articulation, although this is not essential. The pivot 56 is mounted to a block that is movable inside the mast 48.

Referring back to FIG. 1, the preferred brush cutter 20 has an extension 58 on the near end 44 thereof. This extension has a desired length for positioning the brush cutter 20 at a desired lateral distance from the road grader 22. Similarly, the total length of the elongated frame 24 and the number of cutting discs 26 in the preferred brush cutter 20 are determined by choice of the designer.

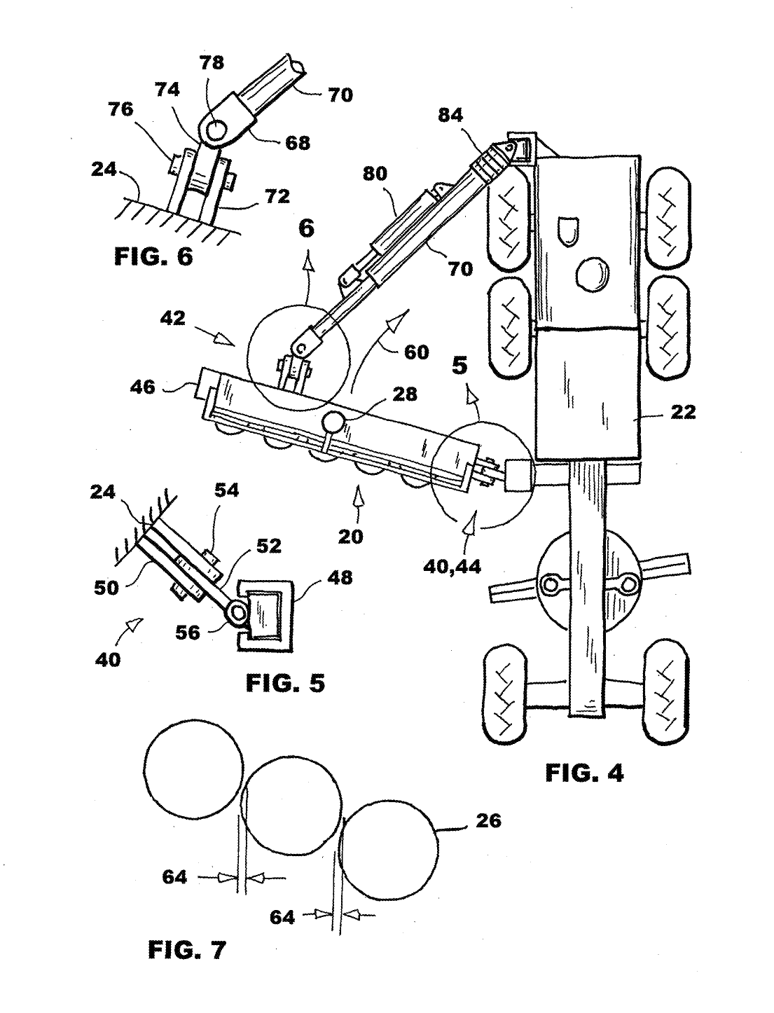

The articulation of the brush cutter 20 is limited to vertical displacement along the mast 48; a horizontal angular sweep as indicated by arrow 60 in FIG. 4 about the pivot 56, and a vertical angular movement in the direction of arrow 62 in FIG. 3, about the pin 54. A restriction in the movement of the preferred brush cutter 20 along these orthogonal planes ensures that the cutting discs 26 remain parallel to the ground surface being cleared.

It will be appreciated that the expression “parallel to the ground” as used herein may also include a setting of each disc 26 where the leading edge thereof is slightly closer to the ground that the trailing edge, for providing a relief in the cut being made.

The movement of the brush cutter 20 about the pivot 56 is provided to set the brush cutter 22 at an angle from the direction of travel of the road grader 22 such that the path of each cutting disc 26 overlap each other slightly as illustrated by arrows 64 in FIG. 7. It will be understood that once this position is set, there is no need for further movement of the brush cutter 20 about the pivot 56, and therefore, this pivot may be replaced by an appropriate curvature in the plate 52, for example.

The far end connection 42 retaining the far end of the brush cutter 20 to the road grader 22 is better illustrated in FIG. 6. The far end connection 42 is made in a similar manner as the near end connection 40. The far end connection 42 is made of a first clevis 68 on the push bar 70 of the road grader 22; a second clevis 72 mounted to the frame 24 of the brush cutter 20, and a linkage 74 joining the first and second clevises 68,72. A horizontal pin 76 extends through the linkage 74 and through the second clevis 72 for providing articulation of the push bar 70 in a vertical plane relative to the position of the brush cutter 20. The linkage 74 is mounted to the first clevis 68 on a vertical pivot 78 for accommodating horizontal angular movement of the push bar 70 relative to the position of the brush cutter 20.

The push bar 70 on the road grader 22 is of the type being extensible by way of a first hydraulic cylinder 80 and raisable by way of a second hydraulic cylinder 82. The push bar 70 is of the type where actuation of both hydraulic cylinders 80, 82 are controlled by hydraulic valves in the wing-plow valve bank as mentioned before.

The push bar 70 on the road grader 22 preferably has a shock absorber 84 thereon to absorb shocks that might be encountered during the operation of the brush cutter 20.

The push bar 70 is mounted to the road grader in a way that is conventional for supporting a wing plow, and therefore no further explanation is deemed necessary relative to this element.

Referring particularly to FIG. 3, it will be appreciated that the structure of the connections 40 and 42 makes it possible to move the brush cutter 20 in many different positions while maintaining the cutting discs 26 in a substantially parallel alignment with the ground surface being cleared. Some of these positions are illustrated in FIG. 3.

The first position of the brush cutter 20 shown at label 90 is a horizontal position where the cutting discs 26 are maintained parallel to a road surface. The second position 92 has the far end 46 of the brush cutter adjusted lower than the near end 44, for clearing a road shoulder that is sloping downward, below a horizontal alignment from the road surface for example. The third position 94 has the far end 46 raised higher than the near end 44 for use when the road grader 22 has one side riding into a ditch 20 for example. The fourth position 96 has both the near end 44 and the far end 46 raised relative to the road surface, for use when the road grader is riding with both sides thereof into a ditch for example. The fifth position 98 has the near end much higher than the far end, for leaping over a driveway marker for example. The position labeled as 100 is a stow away position with the brush cutter 20 raised in a near-vertical alignment.

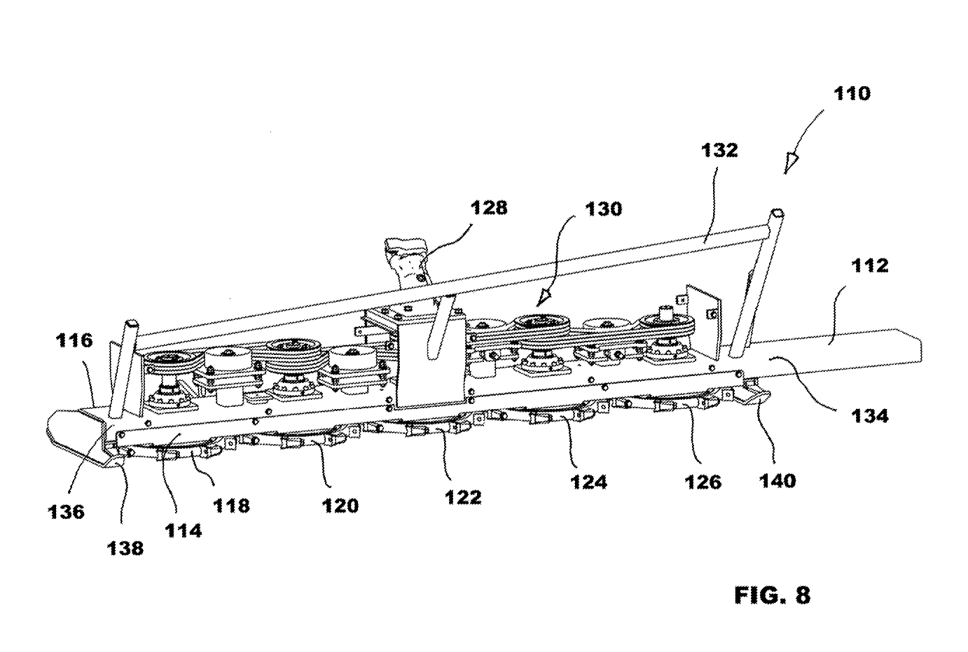

FIG. 8 shows another example embodiment of a brush cutter 110 in detail. The brush cutter 110 has an elongated bar frame 112 with a front side 114 and a rear side 116, and a plurality of adjacent cutting discs 118, 120, 122, 124, 126 extending lengthwisely along it. More particularly, 5 cutting discs are used in this case, although a different number, such as between 3 and 12, preferably between 4 and 8, can be used in alternate embodiments. Each cutting disc can be made of thick steel plates to prevent deformation in use, and can preferably be fitted with replaceable teeth. The rotational speed of these cutting discs is selected to provide cutting and mulching of the material being cleared. The cutting discs all extend along a common plane and protrude slightly out of the front side 114 of the elongated bar frame 112 in order to be exposed to bushes, shrubs, small trees, and the like constituting the brush the brush cutter is intended to cut.

Brush tends to be of highly uneven constitution and it is often the case that not all cutting discs use the same amount of power at the same time. For instance, a small tree is one example of something that requires a significant amount of power to cut through. If a small tree comes into contact with one of the cutting discs while the other cutting discs are only in contact with softer material, the specific disc the small tree is in contact with will require power to be cut by the cutting disc it is against, but the other cutting discs will likely not require as much power. Statistically, it can be highly unlikely that power above a given specified requirement be required at any given time. Henceforth, in this embodiment, a single motor 128 (hydraulic in this case) is used, the power of which is distributed amongst the cutting discs by a power transfer mechanism 130. It will now be understood that this arrangement can be significantly less costly than providing each one of the cutting discs with a specific motor offering the maximum power each individual cutting disc is expected to require at some point in time.

In this specific embodiment, the motor 128 is directly mounted on the shaft of one of the cutting discs and the power is distributed to the shafts of the other cutting discs by corresponding belt and sheave arrangements. More specifically, one belt and sheave arrangement including its tensioning pulley is used between each pair of adjacent cutting discs. Belt and sheave arrangements were used in this example rather than gearing or chain and sprocket arrangements given that they allowed satisfactory performance at a lower cost. Moreover, it will be noted that the motor 128 is mounted on the shaft of a central one of the cutting discs 122 in this embodiment, and therefore transfers power to cutting discs located on both sides. Henceforth, to reach the cutting discs 126, 118 located at each opposite end, the power is carried across a maximum of two belt and sheave arrangements. This configuration is believed to lead to a lesser likelihood of belt failures than an embodiment where the motor would be located at one end of the elongated frame and the power thereby travel across a greater number of belts, for instance.

In this example where 5 cutting discs are used, each having a 2 or 2¼″ kerf, triple sheave arrangements were found to offer satisfactory ruggedness and to be better than double sheave arrangements. It will be noted that a housing or cover, not shown in FIG. 8, is used to cover and protect the power transfer mechanism 130 during use.

The brush cutter 110 also has a brush deflector bar 132 mounted on the front side thereof to deflect small trees downward in the front of and under the brush cutter 110. In the specific example shown in FIG. 8, the brush cutter is designed for use in a wing-plow application such as presented above. The elongated bar frame 112 can thus be said to have a proximal end 134 intended to be near the vehicle during use, and a distal end 136 opposite the proximal end 134. Rather than being parallel to the elongated frame 112, the brush deflector bar 132 slopes both downwardly and rearwardly from the proximal end 134 to the distal end 136. In a wing plow application, an objective is to push trees both downwardly and outwardly, away from the vehicle. This oblique sloping configuration can help achieving this.

It will also be noted that in this specific embodiment, a pair of runners 138, 140 is provided with the frame. Each one of the runners 138, 140 is provided at a corresponding end 136, 134 of the frame 112, adjacent a corresponding one of the end cutting discs 118, 126. Both are made integral to the frame 112 and protrude downwardly from the plane of the cutting discs in a manner that if the frame 112 is lowered too close to the ground, one, or both of the runners 138, 140 will come into engaging contact with the ground rather than the cutting discs themselves.

Although an example embodiment of a brush cutter and its mounting have been illustrated on a road grader, those skilled in the art will understand that a same mounting can be done on a snow plow truck, a front end loader or another road vehicle having wing-plow attachments. Also, a sickle-bar type brush cutter or other brush mower may also be mounted to the wing-plow attachments in a similar way as described herein for providing similar results as those described herein. Finally, it will be noted that in light of the teachings above, a brush cutter can be adapted for other types of mountings, such as a central mounting on a tractor, for instance. Therefore, the above description should not be construed as limiting the scope of the invention.

1. A road vehicle having wing-plow attachments and a brush cutter mounted as a wing plow to said wing-plow attachments;
said brush cutter having an elongated frame, and
said wing-plow attachments comprising a wing-plow mast having a first raisable connection and a wing-plow push bar having second raisable connection, said elongated frame being connected at both ends thereof to said first and second raisable connections respectively, such that said both ends being independently adjustable in height by said wing-plow mast and said wing-plow push bar.

2. The road vehicle as claimed in claim 1, wherein said wing-plow attachments are operable by hydraulic valves belonging to a wing-plow valve bank.

3. The road vehicle as claimed in claim 1, wherein the first raisable connection comprises a horizontal pin and means for limiting an articulation of said brush cutter about said horizontal pin.

4. The road vehicle as claimed in claim 3, wherein said second raisable connection comprises a second horizontal pin and means for moving said second connection above and below said first connection.

5. The road vehicle as claimed in claim 4, wherein said push bar and said second connection have means for moving said brush cutter from a stowed position extending along a near vertical alignment to an operating position extending below a horizontal alignment.

6. The road vehicle as claimed in claim 1 wherein each of said first and second connections has horizontal and vertical axes of articulation.

7. The road vehicle as claimed in claim 1, wherein said brush cutter has a series of cutting discs mounted in line along said elongated frame and wherein each of said cutting discs is made of thick plate and has hardened-steel teeth thereon.

8. The road vehicle as claimed in claim 7, wherein said brush cutter is aligned such that paths of said cutting discs overlap each other.

9. The road vehicle as claimed in claim 8, wherein said brush cutter has a brush deflector bar mounted on the front side thereof.

10. A road vehicle having wing-plow attachments and a brush cutter mounted as a wing plow to said wing-plow attachments; said brush cutter having an elongated frame and a series of cutting discs mounted in line along said elongated frame, and said wing-plow attachments comprising a wing-plow mast having a first raisable connection and a wing-plow push bar having second raisable connection, said first and second raisable connections having horizontal and vertical axes of articulation; said elongated frame being connected at both ends thereof to said first and second raisable connections respectively, such that said both ends are independently adjustable in height by said wing-plow mast and said wing-plow push bar.

11. The road vehicle as claimed in claim 10, wherein said wing-plow attachments are operable by hydraulic valves belonging to a wing-plow valve bank.

12. The road vehicle as claimed in claim 10, wherein the brush cutter being connected to said first raisable connection by a first pin aligned horizontally.

13. The road vehicle as claimed in claim 12, wherein said brush cutter being connected to said second raisable connection by a second pin aligned horizontally.

14. The road vehicle as claimed in claim 10, wherein said push bar and said second connection have means for moving said brush cutter from a stowed position extending along a near-vertical alignment to an operating position extending below a horizontal alignment.

15. The road vehicle as claimed in claim 10, wherein said brush cutter is aligned such that paths of said cutting discs overlap each other.

16. The road vehicle as claimed in claim 10 wherein said brush cutter has a brush deflector bar mounted on the front side thereof.

17. A road vehicle having wing-plow attachments and a brush cutter mounted as a wing plow to said wing-plow attachments; said brush cutter having an elongated frame and a series of cutting discs mounted in line along said elongated frame, and said wing-plow attachments comprising a wing-plow mast having a first raisable connection and a wing-plow push bar having second raisable connection, said first and second raisable connections having horizontal and vertical axes of articulation; said elongated frame being connected at both ends thereof to said first and second raisable connections respectively; and said wing-plow attachments being operable by hydraulic valves mounted in a cab thereof and said hydraulic valves belonging to a wing-plow valve bank.

18. The road vehicle as claimed in claim 17, wherein said push bar and said second connection have means for moving said brush cutter from a stowed position extending along a near-vertical alignment to an operating position extending below a horizontal alignment.

19. The road vehicle as claimed in claim 17, wherein said brush cutter is aligned such that paths of said cutting discs overlap each other.

20. The road vehicle as claimed in claim 17, wherein said brush cutter has a brush deflector bar mounted on the front side thereof.

21. A brush cutter for mounting to a vehicle, the brush cutter having an elongated frame having two opposite ends, and a front edge extending between the two opposite ends; a series of cutting discs all in the same plane, disposed adjacent one another along the elongated frame, each one of the cutting discs being rotatably received in the frame about a corresponding axis normal to the plane and having a cutting diameter protruding from the front edge of the frame; a motor; and a power transfer mechanism interconnecting the motor with a plurality of the cutting discs.

22. The brush cutter of claim 21 wherein each cutting disc is made of thick plate and has a plurality of teeth circumferentially interspaced thereon.

23. The brush cutter of claim 21 wherein the power transfer mechanism connects the motor to between 3 and 12 of the cutting discs, preferably between 4 and 8, and most preferably 5.

24. The brush cutter of claim 21 wherein the motor is directly mounted on the a given one of the cutting discs, and the power transfer mechanism transferring the power to the other cutting discs.

25. The brush cutter of claim 24 wherein the power transfer mechanism has a belt and sheave arrangement connecting each pair of adjacent cutting discs.

26. The brush cutter of claim 24 wherein the cutting disc the motor is directly mounted to has two adjacent cutting discs.

27. The brush cutter of claim 24 comprising five cutting discs, the motor being directly mounted to a central one of the cutting discs, the power transfer mechanism having corresponding belt and sheave arrangements connecting the central cutting disc to two adjacent cutting discs and, in turn, the two adjacent cutting discs to two of the cutting discs provided at the end of the series.

28. The brush cutter of claim 21 further comprising a brush deflector bar positioned upward and frontward of the front edge of the frame, extending between the two opposite ends of the frame, and sloping downwardly and rearwardly from one of the ends to the other one of the ends of the frame.

29. The brush cutter of claim 21 wherein the motor is a hydraulic motor.

30. The brush cutter of claim 21 wherein the frame further comprises a runner at each one of the ends, the runners protruding downwardly below the plane of the discs.
